(19) United States
(12) Patent Application Publication
(10) Pub. No.: US 2007/0102231 A1
(43) Pub. Date: May 10, 2007

(54) Connecting sheet of paper cone

(76) Inventor: Hiroshi Ohara, U-Lin Village (JP)

Correspondence Address: BIRCH STEWART KOLASCH & BIRCH, PO BOX 747, FALLS CHURCH, VA, 22040-0747, US

(21) Appl. No.: 11/270,571

(22) Filed: Nov. 10, 2005

(51) Int. Cl. H04R 7/00

(52) U.S. Cl. 181/171; 181/172

(57) ABSTRACT

A connecting sheet of a paper cone is provided. After overlapped, the two different surface material layers with different properties are combined together by pressurizing and heating them in a mold, and subsequently are made into an annular connecting sheet which has an arc portion with an inward extending end, and an outward extending end. The inward extending end portion is used to attach to the paper cone, and the outward extending end portion is used to attach to the iron frame of the loudspeaker. Therefore, the drawbacks of the conventional connecting sheet composed of only one surface material can be overcome, and a good acoustic quality of a loudspeaker can be obtained.

### FIELD OF THE INVENTION

The present invention relates to an element used in a loudspeaker, and more particularly to a connecting sheet used to attach a paper cone to an iron frame of a loudspeaker.

### BACKGROUND OF THE INVENTION

A typical dynamic loudspeaker, as shown in FIG. 1, usually includes a motive power system, a paper cone, and a suspension system. The motive power system further includes a permanent magnet, an electrode piece, an upper iron, gap, and a voice coil. The paper cone A, which is a diaphragm for moving air, is generally formed as a conic or semi-spherical acoustic bowl. The suspension system, which is composed of a damper B and a suspension rim, is provided for drawing the paper cone A to move in a specified direction.

The dynamic loudspeaker works in such a way that an electromagnetic field, which is in a direction perpendicular to the magnetic field of the permanent magnet of the loudspeaker, is generated by flowing a current through the voice coil of the loudspeaker, and the generated electromagnetic field causes the movable coil to oscillate within a gap (a space between the voice coil and the permanent magnet), and thereby the diaphragm attached to the voice coil is able to vibrate up and down and reproduce sound at the frequency of the applied electrical signal. Therefore, an electrical signal can be converted into sound in a loudspeaker.

A conventional paper cone of a loudspeaker is a cone-shaped bowl that has a hole at the center for disposing a voice coil, and the conventional cone is commonly made of one layer of cloth, paper, or rubber, and them can further combine with a metal. Moreover, the upper edge of the paper cone is attached to a connecting sheet that is further attached to the inner rim of the iron frame of the loudspeaker so that the paper cone is suspendedly affixed to the iron frame.

As shown in FIG. 2, the conventional connecting sheet A of the paper cone is a integrally formed annular ring which is made of rubber. The connecting sheet A has an arc portion A1 with an inward extending end A2, and an outward extending end A3. The inward extending end portion A2 is used to attach to the upper edge of the paper cone, and the outward extending portion A3 is used to attach to the inner rim of the iron frame of the loudspeaker. The arc portion A1 is used for making the connecting sheet flexible as a spring. The drawbacks of the conventional connecting sheets of the paper cones are that the connecting sheets are relatively heavy; the manufacturing cost for them are high because the integrally forming step is time-consuming; the connecting sheets are monochromatic because the rubber is not easily mixed with the pigments; and also the rubber may crack or even fracture as a result of an oxidative process after long use.

### SUMMARY OF THE INVENTION

The objective of the present invention is to solve the problems of the conventional rubber connecting sheet of the paper cone, which is made of only rubber, such as heavy weight, monochromatic color, and cracking after long use.

To achieve the foregoing objective, the present invention provides a connecting sheet of a paper cone, and the connecting sheet is composed of a base surface material layer with enough elasticity and strength, and an elastic surface material layer. After the elastic surface material layer is overlaid on the base surface material layer, the two surface material layers are combined together by pressurizing and heating them in a mold, and subsequently are made into an annular connecting sheet which has an arc portion with an inward extending end, and an outward extending end. The inward extending end portion is used to attach to the paper cone, and the outward extending portion is used to attach to the iron frame of the loudspeaker. The drawbacks of the conventional connecting sheets made of only one surface material can be overcome, and a good acoustic quality of the loudspeaker can be obtained because the connecting sheet of the paper cone of the present invention is composed of a base surface material layer with enough elasticity and strength, and an elastic surface material layer.

As comparing with the conventional rubber connecting sheet of the paper cone, the connecting sheet of the paper cone of the present invention is composed of two different surface material layers with different properties so that the total weight of the connecting sheet of the paper cone of the present invention can be lighter, and meanwhile the desired elasticity and strength can be obtained. In addition, the connecting sheet of the present invention can be painted with various pigments so that the loudspeakers can look more colorful. Moreover, the connecting sheet of the paper cone of the present invention can be used without cracking for a long time.

### BRIEF DESCRIPTION OF THE DRAWINGS

The drawings included herein provide a further understanding of the invention. A brief introduction of the drawings is as follows

FIG. 1 is a cross-sectional view of the loudspeaker known in the prior art;

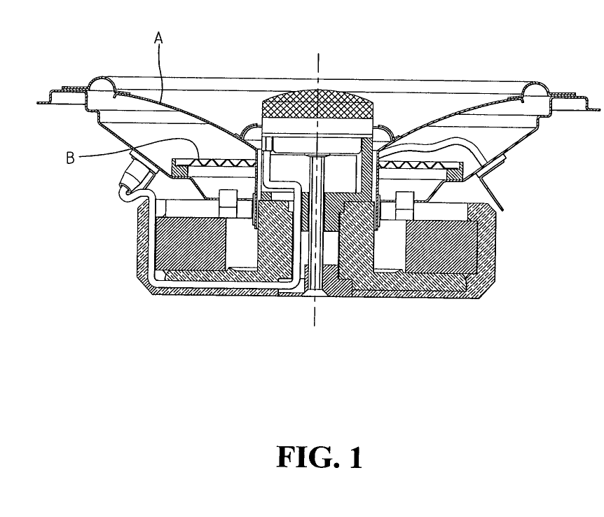

FIG. 2 is a cross-sectional view of the paper cone attached with the connecting sheet known in the prior art;

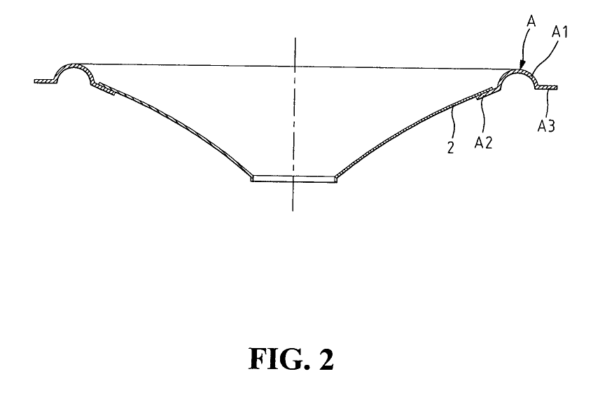

FIG. 3 is a cross-sectional view of the paper cone attached with the connecting sheet in accordance with the present invention; and

FIG. 4 is a locally enlarged view of the portion X shown in FIG. 3.

### DETAILED DESCRIPTION OF THE PREFERRED EMBODIMENT

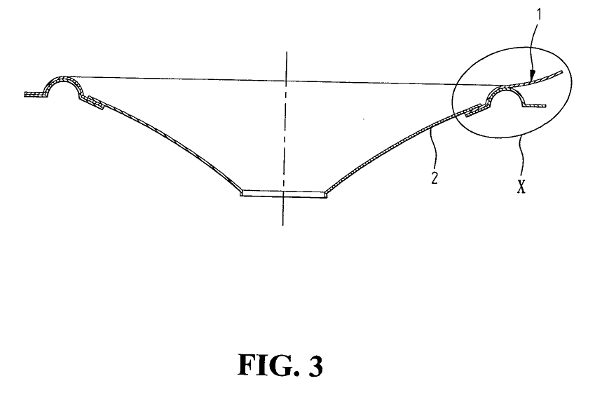

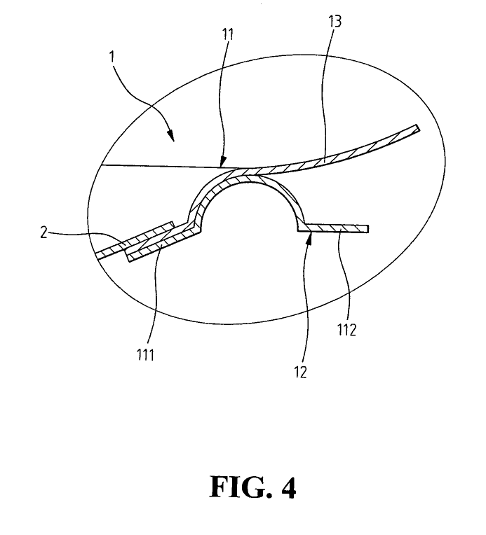

As shown in FIGS. 3 and 4, two different surface material layers with different properties are overlapped with each other, and then are combined together by pressurizing and heating them in a mold, and subsequently are made into a connecting sheet 1 which has an arc portion 11 with an inward extending end 111, and an outward extending end 112.

In this embodiment, the thin cloth with enough elasticity and strength is used as a base surface material 12, and an elastic rubber material is used as an elastic surface material 13. After the elastic surface material layer 13 is overlaid on the base surface material layer 12, the two surface material layers are combined together by pressurizing and heating them in a mold, and subsequently are made into an annular connecting sheet 1 which has an arc portion 11 with an inward extending end 111, and an outward extending end 112.

After the completion of the connecting sheet 1, the connecting sheet 1 is attached to the paper cone by applied an adhesive on the upper surface of the inward extending end portion 111 and attached the upper surface of the inward extending end portion 111 to the lower surface of the upper edge of the paper cone 2. The connecting sheet 1 is attached to the iron frame of the loudspeaker by applied an adhesive on the lower surface of the outward extending end portion 112 and attached the lower surface of the outward extending end portion 112 to the inner rim of the iron frame. In such a way, the paper cone 2 is suspendedly affixed to the iron frame through the connecting sheet 1.

The advantages of the connecting sheet of the paper cone of the present invention at least include:

1. The thin cloth (as lower layer) which is used as the base surface material has elasticity so that it is not easily fractured, and thereby the thin cloth is able to tolerate the pulling and pushing force produced by the oscillation of the paper cone for a long time.

2. The total weight of the connecting sheet of the present invention is lighter than that of the conventional one because the connecting sheet of the present invention is made of both the thin cloth and the rubber material instead of only the rubber material.

3. The elastic rubber material (as upper layer), such as polyurethane, which is used as the elastic surface material is characterized in that it is able to absorb the oscillation of the paper cone, which is produced with a change in the frequency of the applied electrical signal. Moreover, the elastic surface material can mix with various pigments so that a variety of color loudspeaker can be manufactured, and that will stimulate the purchasing desire of the consumers.

It will be apparent to those skilled in the art that various modifications and variations can be made in the present invention without departing from the spirit or scope of the present invention. Thus, it is intended that the present invention cover the modifications and the variations of this invention provided they come within the scope of the appended claims and their equivalents.

What is claimed is:

1. A connecting sheet of a paper cone, comprising:
a base surface material layer;
an elastic surface material layer overlaid on the base surface material layer; and
the base surface material layer and the elastic surface material layer overlaid on the base surface material layer being combined together by pressurizing and heating them in a mold, and subsequently being made into an annular connecting sheet that has an arc portion with an inward extending end, and an outward extending end.

2. The connecting sheet of a paper cone as claimed in claim 1, wherein the base surface material layer is made of a thin cloth.

3. The connecting sheet of a paper cone as claimed in claim 1, wherein the elastic surface material layer is made of a rubber material.

4. The connecting sheet of a paper cone as claimed in claim 3, wherein the rubber material is polyurethane.
